(19) United States
(12) Patent Application Publication
(10) Pub. No.: US 2019/0154131 A1
(43) Pub. Date: May 23, 2019

(54) ELECTRICALLY DRIVABLE SWIVELING DEVICE

(71) Applicant: UNIVER S.p.A., Milano (IT)

(72) Inventor: Luciano Migliori, Mailand (IT)

(73) Assignee: UNIVER S.p.A., Milano (IT)

(21) Appl. No.: 16/197,386

(22) Filed: Nov. 21, 2018

(30) Foreign Application Priority Data
Nov. 22, 2017 (EP) 17202961.3

(51) Int. Cl. F16H 57/022; H02K 7/116; F16H 19/00; F16H 1/20; F16H 57/039; F16C 19/36; B25J 9/00

(52) U.S. Cl. CPC F16H 57/022; H02K 7/1166; F16H 19/001; F16H 1/203; F16H 2057/0213; F16C 19/364; B25J 9/0009; H02K 2201/18; F16H 57/039

(57) ABSTRACT

A swiveling device includes a head part and a drive part, the drive part having an electric motor and the head part having a worm gearing, which can be driven by means of the electric motor, the worm gearing having a drive-side shaft with at least one screw thread and a helical gear wheel meshing therein, an output shaft being drivable by means of the gear wheel and the output shaft being connected for conjoint rotation to at least one swiveling element, and the drive-side shaft being mounted on both sides of its at least one screw thread in a housing of the head part by means of rolling bearings. The drive-side shaft is adjustable with respect to its axis of rotation in a plane arranged perpendicular to the axis of rotation of the gear wheel by an adjustment component of the drive-side shaft perpendicular to its axis of rotation.

### FIELD OF THE INVENTION

The invention relates to a swiveling device comprising a head part and a drive part, the drive part having an electric motor and the head part having a worm gearing which can be driven by means of the electric motor, the worm gearing having a drive-side shaft with at least one screw thread and a helical gear wheel meshing therein, an output shaft which is led out of the head part being drivable by means of the wheel and the output shaft being connected for conjoint rotation to at least one swiveling element, and the shaft being mounted on both sides of its at least one screw thread in a housing of the head part by means of rolling bearings.

### Background of the Invention and Related Art

Swiveling devices are used in diverse structures in body manufacturing in the motor vehicle industry. A specific tool can be connected here to the at least one swiveling element of the swiveling device in order in particular to realize the function of a clamping device, welding tongs, a stamping tool, a clinching tool or a pin locating cylinder. Depending on requirements, a toggle lever function can be integrated in the swiveling device in order to ensure a secure end positioning of the tool in a position of the toggle lever beyond the dead center.

A swiveling device of the type mentioned at the beginning, which therefore has an electromotive drive, is known from WO 03/047815 A1. In the case of this swiveling device, a worm gearing can be driven via an electric motor. The worm wheel of the worm gearing cooperates with a toggle lever which, for its part, cooperates with the output shaft which is led out of the head part and is connected for conjoint rotation to the swiveling element. By means of a reversal in the direction of rotation of the electric motor, the worm wheel and therefore the swiveling element can be swiveled to and fro. The electric motor is in the form of an AC motor or three-phase motor. For the mounting of the shaft of the worm gearing, two rolling bearings are provided which mount the shaft on both sides of the at least one screw thread of the shaft. Said rolling bearings are needle bearings, ball bearings or the like.

Swiveling devices of the type mentioned at the beginning are subject to wear even in the region of the worm gearing. As the duration of operation of the swiveling device progresses, increased play can be noted in the worm, with the consequence that the positioning accuracy, and therefore the angular accuracy, of the at least one swiveling element is reduced during the operation by means of the electric motor and, furthermore, the noise behavior of the swiveling device is disadvantageously developed because of the increased play. A reduced angular accuracy of the swiveling element causes an imprecise positioning of the tool, in particular in an end position of the swiveling element.

### OBJECT AND SUMMARY OF THE INVENTION

It is the object of the present invention to develop a swiveling device of the type mentioned at the beginning in such a manner that freedom from play of the swiveling device, in particular in the region of the worm gearing, is ensured.

In the case of the swiveling device according to the invention, the shaft is adjustable with respect to its axis of rotation, in a plane, which is arranged perpendicular to the axis of rotation of the wheel, by an adjustment component of the shaft perpendicular to its axis of rotation.

In the case of the swiveling device according to the invention, there is therefore the possibility of orienting the shaft of the worm gearing in different positions with respect to the wheel of the worm gearing and, by bringing about a different oriented position, of eliminating play between the at least one screw thread of the shaft and the helical gear wheel meshing therein. Play in the worm gearing can therefore be eliminated, and, accordingly, play between the at least one screw thread, also called worm, and the helical gear wheel meshing therein, also called worm wheel, can be eliminated. By means of this possibility of adjusting the shaft relative to the wheel, optimum engagement of the teeth of screw thread and wheel can be ensured, with an optimum distance of axis of rotation of the shaft and axis of rotation of the wheel being brought about in a simple manner.

Regarding the basic configuration of the swiveling device, it is provided in particular that the electric motor is in the form of a DC motor or AC motor. These electric motors are preferably in the form of commercially available motors.

The swiveling device is preferably configured in such a manner that the shaft of the worm gearing can be driven by means of the electric motor in one direction of rotation and in a direction opposed to said direction of rotation. The swiveling device therefore serves for swiveling the at least one swiveling element in one direction and back in the opposite direction.

It is entirely also possible for the swiveling device to also have an intermediate gearing. In this respect, it is considered preferred if a drive shaft of the electric motor is connected to the shaft of the worm gearing via the intermediate gearing, in particular a spur gearing. This makes it possible to achieve a particularly large reduction in the rotational speed of the electric motor in order to achieve swiveling of the swiveling element at a precise angle.

In particular, the wheel is connected to the output shaft for conjoint rotation. The worm gearing therefore cooperates directly with the output shaft which, for its part, is connected to the at least one swiveling element for conjoint rotation. In this basic configuration, no toggle lever is therefore arranged between the wheel of the worm gearing and the output shaft. When the components within the swiveling device are free from play, a rotational movement of a rotor of the electric motor therefore leads to an exact proportional swiveling movement of the at least one swiveling element.

The electric motor is preferably in the form of a stepping motor. By this means, desired angular positions of the swiveling element can be defined and can also be approached in small angular steps. The embodiment with a stepping motor in particular has a self-driven multi-range encoder. A supply and a buffer battery are therefore not required. The electric motor can preferably alternatively be in the form of a brushless motor.

The swiveling device is preferably provided with one or two swiveling elements. The swiveling element or the two swiveling elements are connected fixedly, in particular releasably, to the output shaft and serve for receiving the tool or tools suitable for the specific intended application. Said tools are generally connected releasably to the associated swiveling element in a suitable manner. Said tools are preferably tools which are used in body manufacturing in the motor vehicle industry, such as a clamping device, welding tongs, a stamping tool, a clinching tool or a pin locating cylinder.

According to a preferred embodiment of the invention, it is provided that the shaft of the worm gearing is adjustable by means of an adjusting device. In particular, it is provided that the shaft is adjustable in an infinitely variable manner by means of the adjusting device. The adjusting device can be used to position the shaft in a simple manner in the desired position with respect to the wheel, and therefore to precisely position the worm with respect to the worm wheel.

It is considered to be structurally particularly advantageous and functionally particularly simple if the adjusting device can be used to adjust a bearing receptacle of one of the rolling bearings, in particular to adjust the bearing receptacle in a manner guided in the housing. Said rolling bearing is therefore not directly accommodated by the housing, but rather by a bearing receptacle. Said bearing receptacle is accommodated by the housing, wherein the bearing receptacle is adjustable in a manner guided in the housing. By means of the adjusting device, said rolling bearing can be simply moved in the direction of the worm wheel or away from the latter and can therefore adjust the play between worm and worm wheel.

According to a structurally particularly simple and particularly functional configuration, it is provided that the adjusting device has at least one adjusting screw screwed into the housing, wherein the bearing receptacle is adjustable by means of the adjusting screw. The adjusting screw on account of the thread thereof can be screwed very precisely into the housing to a greater or lesser extent and can therefore ensure the adjustment of the shaft in a very precise manner. It is of particularly great advantage if the at least one adjusting screw is received in a self-locking manner by the housing. This ensures that the adjusting screw retains its adjusted position.

It is provided in particular that the adjusting device can be used to adjust the bearing receptacle of that rolling bearing which supports the shaft in a manner averted from the electric motor or the intermediate gearing. If the shaft is only adjusted by means of said adjusting device, in the present case in the one region of the shaft, this leads to the shaft being slightly swiveled during the adjustment about the rolling bearing which faces the electric motor or the intermediate gearing. Said swiveling movement brings about a change in position of worm and worm wheel, and therefore a change in the play therebetween.

The mounting of the shaft is structurally particularly simple if at least the rolling bearing assigned to the adjusting device is in the form of a tapered roller bearing. In particular, it is provided that all of the rolling bearings, and therefore the two rolling bearings basically provided for the mounting of the shaft, are in the form of tapered roller bearings. The tapered roller bearings have the advantage that they can absorb axial and radial forces and, furthermore, in the case of the respective tapered roller bearing, the inner ring thereof and the outer ring thereof, which accommodate the tapered rollers therebetween, are positioned loosely with respect to each other. This rolling bearing is particularly readily suitable for swiveling the axis of rotation of the shaft.

According to a particular development of the invention, it is provided that at least one of the rolling bearings, preferably all or both rolling bearings, is or are axially supported via at least one disk spring, preferably a plurality of disk springs. Said disk spring or said disk springs is or are of advantage in several respects. An axial force acts on the rolling bearing via the respective disk spring, depending on the arrangement of the disk spring on the inner ring or the outer ring of the rolling bearing, wherein preferably a configuration is provided such that the respective disk spring acts on the inner ring of the rolling bearing. The disk spring is readily suitable not only for exerting a prestress on the shaft of the worm gearing, but also of absorbing forces from the displacement of the shaft, in particular the slight swiveling of the axis of rotation of the shaft. Apart therefrom, the respective disk spring also serves as a damper during possible impacts or sudden braking operations which act on the at least one swiveling element of the swiveling device via the tool.

When the elastic elements are in the form of disk springs, it is considered particularly advantageous if the respective rolling bearing is supported via two disk springs arranged in opposite directions. By this means, a compression of the shaft, and therefore the mounting thereof, over a yet greater axial length is possible, in particular for the purpose of damping or swiveling in order to compensate for play. The elastic deformation of the disk springs ensures that the shaft resumes its initial position after the possible impacts or sudden braking operations.

It is considered to be structurally particularly advantageous, in particular from the aspect of a particularly simple configuration, if an inner ring, which serves for receiving the shaft, of at least one of the rolling bearings is axially supported via the at least one disk spring, preferably the plurality of disk springs. The shaft is therefore supported in each case via the inner ring or the inner rings of the rolling bearing or the rolling bearings.

According to a specific development, it is provided that the inner ring is supported via two disk springs arranged in opposite directions, wherein the disk springs do not make contact in their radially inner region.

The respective rolling bearing is in particular firstly supported between the shaft and secondly between the housing or a part connected in the housing, in particular a cover.

Further features and advantages of the invention will be apparent from the following detailed description of exemplary embodiments, the description of the figures and in the figures themselves.

### BRIEF DESCRIPTION OF THE DRAWING FIGURES

The invention is illustrated in the accompanying drawing figures with reference to one or more exemplary embodiments without being restricted to the exemplary embodiment described herein.

FIG. 1 shows a three-dimensional view of a swiveling device according to the invention.

FIG. 2 shows a section through the swiveling device according to FIG. 1 in an X-Z plane, sectioned by the axis of rotation of the worm shaft, illustrated only for the region of a head part of the swiveling device.

FIG. 3 shows the upper rolling bearing according to FIG. 2 in an enlarged illustration.

FIG. 4 shows the lower rolling bearing according to FIG. 2 in an enlarged illustration.

FIG. 5 shows a three-dimensional view of a partial region of the head part of the swiveling device with the two housing parts of the housing of the swiveling device partially sectioned.

FIG. 6 shows a section through the swiveling device in an X-Y plane, sectioned by the upper rolling bearing.

FIG. 7 shows a view Y of the upper, right region of the swiveling device that is shown in FIG. 5.

FIG. 8 shows an enlarged illustration of the region framed in FIG. 6.

FIG. 9 shows a section through the swiveling device in the region of the upper rolling bearing to clarify the mounting, which is displaceable in the X direction, of the rolling bearing in the housing.

FIG. 10 shows the worm gearing and the mounting thereof with an illustration of the ability of the worm to swivel about the angle α during shifting of the upper rolling bearing thereof in the X direction.

FIG. 11 shows a section corresponding to FIG. 2, but illustrated for the entire swiveling device.

### DETAILED DESCRIPTION OF EXEMPLARY EMBODIMENTS OF THE INVENTION

The X, Y and Z directions referred to in the description of the figures for the exemplary embodiment are each perpendicular to one another. However, it is basically not required for said directions to be perpendicular to one another.

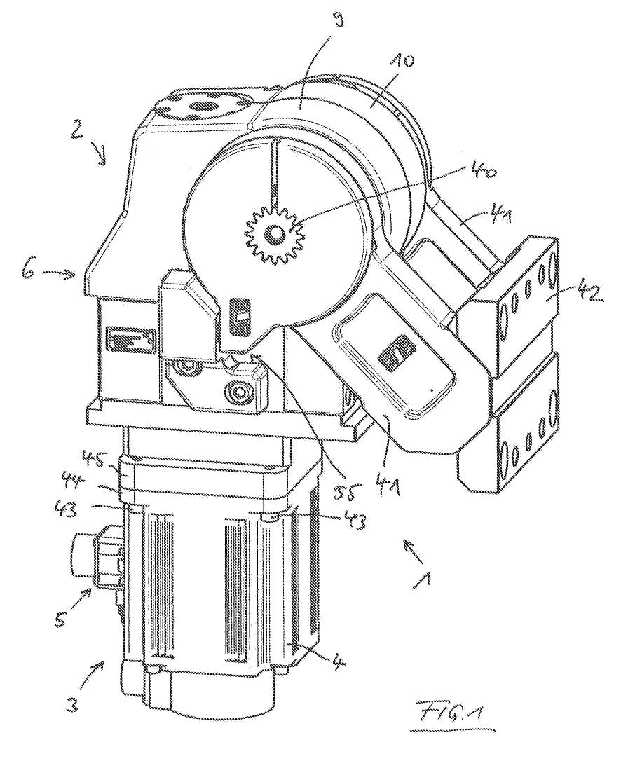

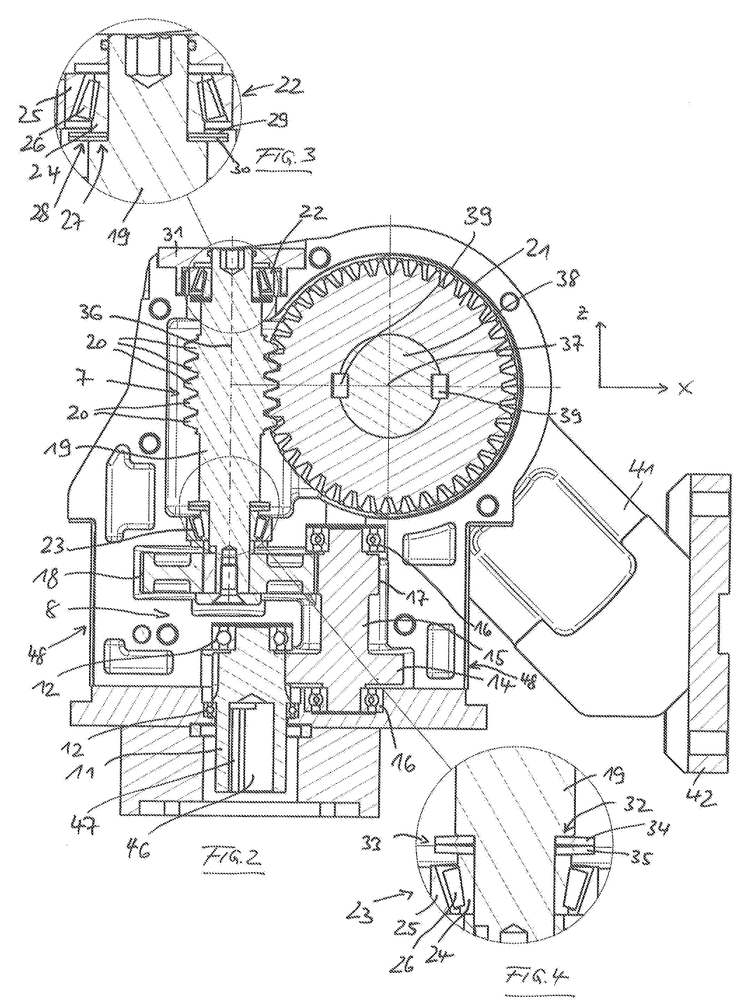

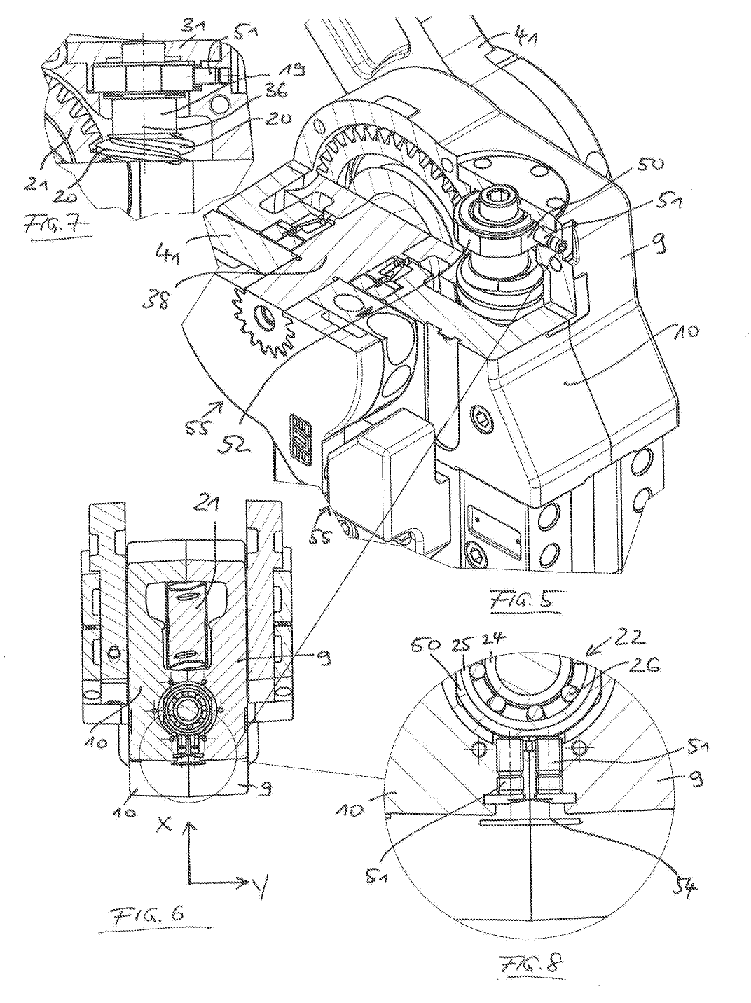

FIGS. 1 and 2 and also FIG. 11 clarify the basic design of the swiveling device 1. The latter has a head part 2 and a drive part 3. The drive part 3 has a housing 4 and an electric motor 56 which is accommodated by the latter and is in the form of a stepping motor. A unit of the drive part 3 that has electrical connections, displays and input keys for the swiveling device is illustrated by the reference number 5. A rotor shaft 57 of the electric motor 56 is led out of the housing 4 upward, with respect to the orientation of FIG. 1.

In connection with the design of the drive part 3, FIG. 11 additionally illustrates the electrical winding 58 of the electric motor 56, a brake 59 which can be brought into operative connection with the rotor shaft 57, an encoder 60, connections 61 for the stepping motor and connections 62 for the brake 59 and the encoder 60.

The head part 2 has a housing 6 in which a worm gearing 7 and an intermediate gearing 8 are mounted. The housing 6 consists here of housing halves 9 and 10. The latter are screwed to each other by means of a multiplicity of screws extending in the Y direction.

In the Z direction, the head part 2 has, in the region of its lower end, a shaft 11 which serves for receiving the rotor shaft 57 of the electric motor 56 in a torque-transmitting manner. Said shaft 11 is mounted in two rolling bearings 12 which are mounted in the housing 6. The shaft 11 has a spur wheel tooth portion 13 between the two rolling bearings 12. Said spur wheel tooth portion meshes with a spur wheel 14 of an intermediate shaft 15 which is mounted in two rolling bearings 16 which are mounted in the housing 6. A second spur wheel 17 of the intermediate shaft 15 meshes with a spur wheel 18 which is connected for conjoint rotation to a drive-side shaft 19 of the worm gearing 7.

The worm gearing 7 has said drive-side shaft 19 with a plurality of screw threads 20 and a helical gear wheel 21 meshing therein. The worm which is assigned to the shaft 19 therefore meshes with the worm wheel 21. The shaft 19 is mounted, with respect to the orientation of FIG. 2, at its upper end in a rolling bearing 22 and above the spur wheel 18, and therefore between the spur wheel 18 and the screw threads 20, in a rolling bearing 23. The two rolling bearings 22, 23 are in the form of tapered roller bearings, with an inner ring 24, an outer ring 25 and taper rollers 26 arranged in between. Adjacent to the rolling bearing 22, the shaft 19 has an offset 27 to the effect that said shaft tapers to the end facing said rolling bearing 22. A disk spring package 28 formed from two disk springs 29, 30 is arranged in the region of the offset. The two disk springs 29 and 30 abut radially on the outside and are spaced apart slightly radially on the inside. The disk spring 29 is supported on the inner ring 24 and the disk spring 30 is supported on the offset 27 of the shaft 19. The outer ring 25 of the rolling bearing 22 is prestressed via a housing component. Said housing component is specifically a cover 31 which is inserted in a centered manner into the two housing halves 9, 10 and is screwed thereto by means of a plurality of screws.

The mounting of the shaft 19 in the region of the other rolling bearing 23 takes place similarly to the previously described mounting: the shaft 19 has an offset 32, where the shaft 19 tapers in the direction of the rolling bearing 23. A further disk spring package 33 which has two disk springs 34, 35 is arranged in the region of said rolling bearing 23. The two disk springs 34, 35 abut radially on the outside and the disk spring 34 is supported radially on the inside on the shaft 19 in the region of the offset 32, and the disk spring 35 is supported on the inner ring 24 of the rolling bearing 23. The outer ring 25 of the rolling bearing 23 is supported on offsets of the housing halves 9 and 10. The shaft 19 is therefore substantially secured axially, apart from the compression possibility in the axial direction of the shaft 19 because of the two disk spring packages 28 and 33.

The axis of rotation of the shaft 19 is denoted with the reference number 36, and the axis of rotation of the wheel 21 with the reference number 37. An output shaft 38 is mounted rotatably in the two housing halves 9 and 10 which are screwed to each other, said output shaft being connected for conjoint rotation to the wheel 21 of the worm gearing 7 via adjustment springs 39. The axial mounting of the wheel 21 in the housing 6 is not illustrated specifically. The output shaft 38 is led out of the housing 6 on both sides and therefore passes through the housing halves 9 and 10. The output shaft 38 is in the form of a splined shaft 40 in its two end regions which have emerged from the housing 6, and two swiveling elements 41 are plugged onto said splined shaft portions and positioned in an axially secured manner. The two swiveling elements 41 are arranged with identical orientation with respect to the axis of rotation 37. A receiving plate 42 with the two swiveling elements 41 is fixably connected in the region of the free ends thereof. The two swiveling elements 41 and the receiving plate 42 form a swiveling element unit which serves for the mounting and fastening of a tool to be swiveled by means of the swiveling device 1. This is in particular a clamping device, welding tongs, stamping tool, clinching tool or pin locating cylinder used in body manufacturing in the motor vehicle industry.

The swiveling device 1 is formed by the head part 2 and the drive part 3. The drive part 3 is screwed to the head part 2 in the region of a flange 44 by means of diverse screws 43. A flange 45 of the head part 2 abuts here against the flange 44 of the drive part 3. When the head part 2 and drive part 3 are screwed to each other, the drive shaft of the electric motor, in the present case the rotor shaft 57 of the electric motor 56, is plugged into a receptacle 46, which is designed as a blind hole, of the shaft 11. Transmission of torque between the rotor shaft 57 and the shaft 11 of the intermediate gearing 8 is brought about by an adjustment spring 47 inserted into the receptacle 46. The swiveling device 1 forming the unit of head part 2 and drive part 3 is mounted in the region of the head part. For this purpose, the housing 6, specifically the housing halves 8 and 9, has a recessed connecting region 48, in the region of which the head part 2 can be connected, in particular screwed, to the other object. Said other object is in particular a robot arm.

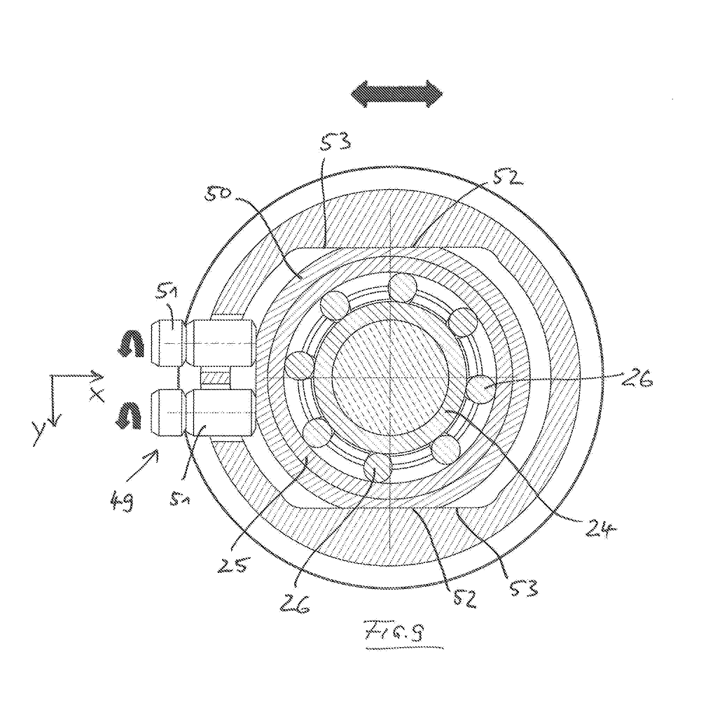

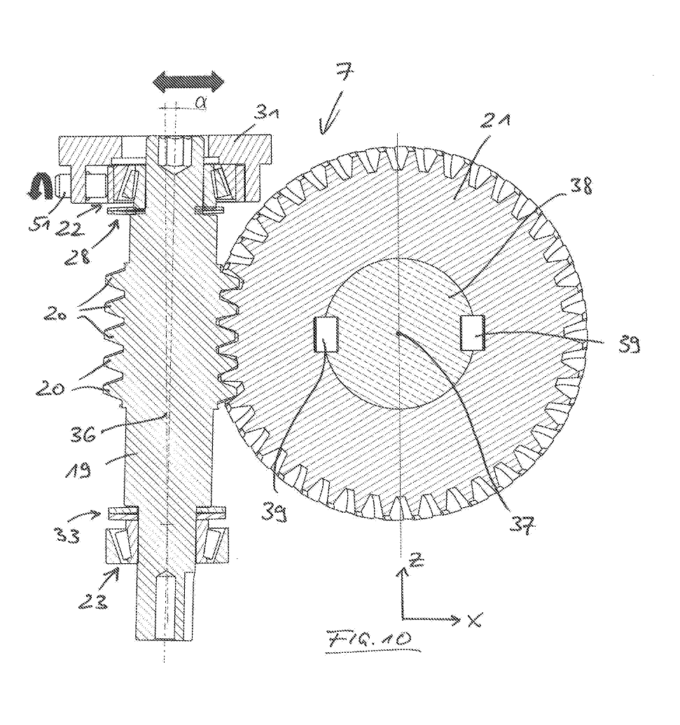

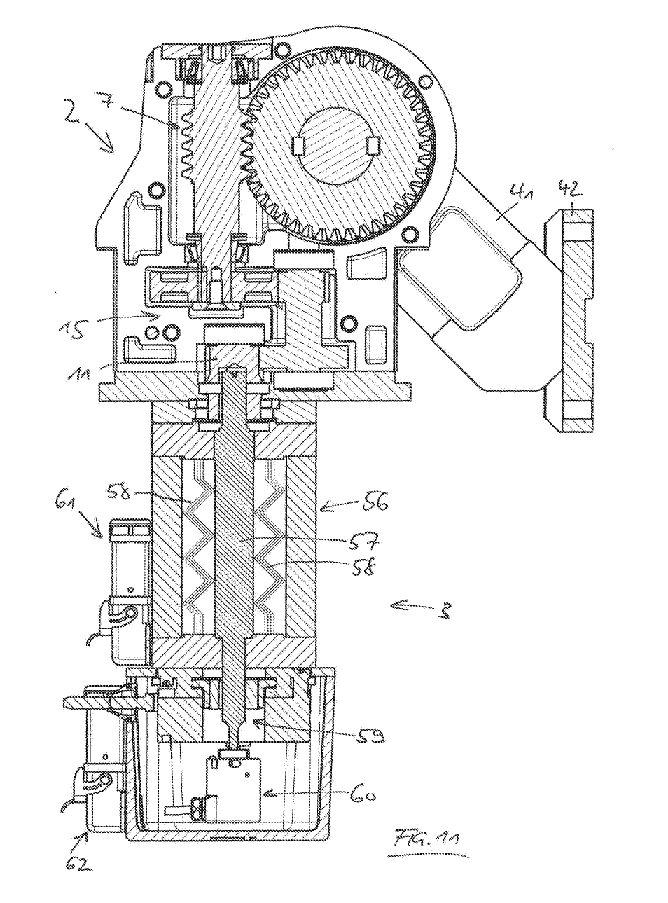

As can be gathered in particular from the illustration of FIGS. 5 to 10, the shaft 19 of the worm gearing 7 is adjustable with respect to the axis of rotation 36 of the shaft 19 in a plane, which is arranged perpendicular to the axis of rotation 37 of the wheel 21, by an adjustment component of the shaft 19 perpendicular to its axis of rotation 36. The shaft 19 can therefore be adjusted in the X-Z plane, perpendicular to its axis of rotation 36, with an adjustment component of the shaft 19. This means that, as can be gathered in particular from the illustration of FIG. 10, the shaft 19 can be slightly tilted into a position in which it is swiveled out of the Z axis by an angle α. This leads to a reduction in the play in the worm gearing 7 because the meshing screw threads 20 plunge deeper between the teeth of the wheel 21. On the other hand, the play can be increased if the shaft 19 is swiveled in the opposite direction.

The described adjustment of the shaft 19 takes place by means of an adjusting device 49. The adjusting device 49 can be used to adjust a bearing receptacle 50 of the rolling bearing 22 in the housing 6, specifically in the two housing halves 9, 10. The adjusting device 49 has two adjusting screws 51 which are screwed into the housing 6. On account of the divided housing 6, an adjusting screw 51 is screwed into the respective housing half 9 or 10, wherein the adjusting screws 51 are arranged symmetrically with respect to the dividing plane of the two housing halves 9, 10. The bearing receptacle 50 is adjustable by means of the two adjusting screws 51. The bearing receptacle 50 receiving the rolling bearing 22 is displaceable in a defined manner in the X direction by means of the adjusting screws 51 because the bearing receptacle 50 has two parallel guides 52 which are arranged in X-Z planes and interact with mating guides 53 of the two housing halves 9, 10, said mating guides running in corresponding planes. By means of uniform adjustment of the preferably self-locking adjusting screws 21, the worm gearing 7 can therefore be adjusted to optimum play between worm and worm wheel. The adjusting screws 51 here have a separate head, as a measure against unauthorized interference. The two adjusting screws 51 are secured against unauthorized interference by means of a board 54.

The tapered roller bearings make it possible for the bearing points to be flexible during deflection of the shaft 19 about the angle α in order to adjust the optimum play in the worm gearing 7. The two disk spring packages 28 and 33 here ensure that the prestress in the rolling bearings 22, 23 is maintained. Said disk spring packages in their property as elastic elements ensure that the screw threads 20 abut against the corresponding teeth of the wheel 21. Said elastic elements/disk springs also serve as dampers during possible impacts or sudden braking operations of the tool received by the swiveling device. The spring force of the disk spring packages can be determined from the aspect of the loading of the swiveling device 1, and therefore in particular of the weight of the tool received by the swiveling device 1 in the region of the receiving plate 42. In particular, the force of the upper disk spring package 28 is lower than the force of the lower disk spring package 33. The upper disk spring package 28 enables the bearings to be prestressed while the lower disk spring package 33 is pressed.

An embodiment with a stepping motor as the electric motor contains in particular a self-driven multi-range encoder 55. A supply and a buffer battery are therefore not required. By reversal of the direction of rotation of the electric motor, the swiveling elements 41 can be swiveled forward and back by the intermediate gearing 8 and the worm gearing 7 when the rotational speed of the electric motor is reduced.

1. A swiveling device comprising a head part and a drive part, the drive part having an electric motor and the head part having a worm gearing driven by means of the electric motor, the worm gearing having a drive-side shaft with at least one screw thread and a helical gear wheel meshing therein, an output shaft of the head part being drivable by means of the gear wheel and the output shaft being connected for conjoint rotation to at least one swiveling element, and the drive-side shaft being mounted on both sides of its at least one screw thread in a housing of the head part by means of rolling bearings, wherein the drive-side shaft is adjustable with respect to its axis of rotation in a plane arranged perpendicular to the axis of rotation of the gear wheel by an adjustment component of the drive-side shaft perpendicular to its axis of rotation.

2. The swiveling device as claimed in claim 1, wherein the electric motor is in the form of at least one of a stepping motor and a brushless motor.

3. The swiveling device as claimed in claim 1, wherein the drive-side shaft of the worm gearing is driven by the electric motor in one direction of rotation and in a direction opposed to said one direction of rotation.

4. The swiveling device as claimed in claim 1, wherein a rotor shaft of the electric motor is connected to the drive-side shaft of the worm gearing via an intermediate gearing.

5. The swiveling device as claimed in claim 1, wherein the gear wheel is connected to the output shaft for conjoint rotation.

6. The swiveling device as claimed in claim 4, wherein the drive-side shaft is adjustable by means of an adjusting device.

7. The swiveling device as claimed in claim 6, wherein the adjusting device is used to adjust a bearing receptacle of one rolling bearing of the rolling bearings in a manner guided in the housing of the head part.

8. The swiveling device as claimed in claim 7, wherein the adjusting device has at least one adjusting screw screwed into the housing of the head part and wherein the bearing receptacle is adjustable by means of the adjusting screw.

9. The swiveling device as claimed in claim 7, wherein the adjusting device is used to adjust the bearing receptacle of the rolling bearing which supports the drive-side shaft in a manner averted from at least one of the electric motor and the intermediate gearing.

10. The swiveling device as claimed in claim 9, wherein at least the rolling bearing which is assigned to the adjusting device is in the form of a tapered roller bearing.

11. The swiveling device as claimed in claim 9, wherein at least one of the rolling bearings is axially supported via at least one elastic element.

12. The swiveling device as claimed in claim 11, wherein the at least one of the rolling bearings is supported via two disk springs arranged in opposite directions.

13. The swiveling device as claimed in claim 11, wherein an inner ring, which serves for receiving the drive-side shaft, of the at least one of the rolling bearings is axially supported via the at least one elastic element.

14. The swiveling device as claimed in claim 13, wherein the inner ring is supported via two disk springs arranged in opposite directions, and wherein the disk springs do not make contact in a radially inner region.

15. The swiveling device as claimed in claim 1, wherein at least one of the rolling bearings is supported firstly between the drive-side shaft and secondly between at least one of the housing of the head part and a cover of the head part.
